(19) United States
(12) Patent Application Publication
(10) Pub. No.: US 2022/0290499 A1
(43) Pub. Date: Sep. 15, 2022

(54) FULL SLEEVE CONCENTRIC LUBRICATOR

(71) Applicant: TIER 1 ENERGY TECH, INC., Edmonton (CA)

(72) Inventors: Mathys Lourens Geldenhuys, Brooks (CA); Clinton Stanley Buttnor, Sylvan Lake (CA)

(21) Appl. No.: 17/692,849

(22) Filed: Mar. 11, 2022

Related U.S. Application Data
(60) Provisional application No. 63/159,607, filed on Mar. 11, 2021.

(51) Int. Cl. E21B 4/00; F16N 7/14

(52) U.S. Cl. CPC E21B 4/003; F16N 7/14

(57) ABSTRACT

A lubricator for receiving a reciprocating plunger has (a) an elongate lubricator body with an inner bore, a lower inlet passage and a side outlet port; (b) an upper lubricator assembly capping an upper end of the lubricator body; and (c) a sleeve extending the length of the lubricator body, and having an outside diameter smaller than an inside diameter of the inner bore, defining an annular flow passage which is in fluid communication with the side outlet port. The sleeve defines an upper hole allowing fluid communication between an inner volume of the sleeve and the annular flow passage, and a lower hole allowing fluid communication between an inner volume of the sleeve and the annular flow passage.

This application claims the priority benefit of U.S Provisional Patent Application No. 63/159,607, filed on Mar. 11, 2021, the entire contents of which are incorporated herein by reference.

### FIELD OF THE INVENTION

The present invention generally relates to a concentric flow lubricator for fluid handling at the wellhead, where a plunger lift system is deployed.

### BACKGROUND

Plunger lift systems are deployed in oil and gas wells where water may accumulate in the well when gas flow from formation is insufficient to remove liquids from the well naturally. As the formation pressure declines and the gas-to-liquid ratio decreases, liquid (generally water) will begin to accumulate in the well. When a produced water column in the wellbore reaches a sufficient height, the resulting hydrostatic pressure will exert pressure on the formation, hindering hydrocarbon flow from the formation up to surface. To overcome this, the water may be removed from the well using an artificial lift system, such as a plunger lift system. In a plunger lift system, a plunger deployed in the wellbore drives liquid up to the surface, acting as a piston sealed within the production tubing inner wall. Gas pressure from below the plunger forces it and the water column above it toward the surface, where the water can be removed, thereby alleviating the pressure on the formation from the water column. This function is performed cyclically, typically without intervention by the operator. The fluid driven upwards by the plunger is ejected through a lubricator which is installed on the top of the wellbore, which has exit ports connected to wellhead equipment to receive and process the fluids.

Plunger lift lubricators often require dual outlet ports to split the flow between an upper and lower port. The upper port flow allows the plunger to be pushed to the top of the lubricator, where it can be captured by a plunger catcher either for removal, delayed dropping with an autocatcher, or to trip a valve style plunger. When a plunger arrives it can block flow through the upper port which chokes the well, reduces production and provides a mechanism for hydrates to form. A lower port is used to allow fluid to flow below the plunger and increase production. Piping, valves and orifices are generally used to adjust the flow between the upper and lower port. Partial sleeve concentric sleeve lubricators are widely used which distribute flow internally without the need for external piping, valves, or chokes. However, partial sleeves often result in unsuccessful plunger capture because the partial sleeve upper port is below the catcher. As a result, a stagnation region may form where fluid may become trapped above the plunger, preventing the plunger from reaching the trip rod or catcher. Furthermore, as well parameters change over time, the ratio of flow between upper port and lower port changes, requiring changes in sleeve configuration. Replacing a partial sleeve necessitates removal of the lubricator top from the concentric block, which often requires a crew, new ring gaskets, and lifting equipment.

Partial sleeves installed in wellhead flow blocks are also used for sand erosion mitigation, redirecting erosion media away from critical areas. Sleeves used for erosion mitigation require frequent inspection and replacement.

There remains a need in the art for a concentric flow lubricator, which may mitigate the disadvantages of prior art solutions.

### SUMMARY OF THE INVENTION

Embodiments of the present invention relate to a lubricator having a full internal sleeve, which allows an upper port to be placed above a plunger catcher. A full sleeve lubricator can be replaced or inspected without removal of a lubricator body from the flow block or wellhead, as the sleeve may be accessed by removing only a lubricator cap.

Therefore, in one aspect, the invention may comprise a lubricator comprising:
(a) an elongate lubricator body, and defining an inner bore, a lower inlet passage and a side outlet port;
(b) an upper lubricator assembly capping an upper end of the lubricator body;
(c) a sleeve extending the length of the lubricator body, and having an outside diameter smaller than an inside diameter of the inner bore, thereby defining an annular flow passage therebetween, the annular flow passage in fluid communication with the side outlet port, wherein the sleeve defines an upper hole allowing fluid communication between an inner volume of the sleeve and the annular flow passage, and a lower hole allowing fluid communication between an inner volume of the sleeve and the annular flow passage.

In another aspect, the invention may comprise a lubricator comprising:
(a) a flow block defining a lower inlet passage, at least one side port, and an upper flow passage;
(b) an elongate lubricator body attached to the flow block, and defining an inner bore in fluid communication with the flow block upper flow passage;
(c) an upper lubricator assembly capping an upper end of the lubricator body;
(d) a cylindrical sleeve having a lower end disposed in the flow block lower inlet passage and an upper end disposed in the lubricator body, and having an outside diameter smaller than an inside diameter of the inner bore and the inside diameter of the flow block upper flow passage, thereby defining an annular flow passage therebetween, the annular flow passage in fluid communication with the side outlet port, wherein the sleeve defines an upper hole allowing fluid communication between an inner volume of the sleeve and the annular flow passage, and a lower hole allowing fluid communication between an inner volume of the sleeve and the annular flow passage.

In another aspect, the invention may comprise a kit comprising a lubricator having a first sleeve and at least one additional different sleeve.

In another aspect, the invention may comprise a method of inspecting or replacing a sleeve within a lubricator, comprising the step of removing an upper lubricator assembly to access the sleeve and removing the sleeve, without further disassembly. Preferably , the upper lubricator assembly is manually removable, more preferably without the use of a tool.

### BRIEF DESCRIPTION OF THE FIGURES

The accompanying drawings, which are incorporated herein and form a part of the specification, illustrate some, but not the only or exclusive, examples of embodiments and/or features.

FIG. 1 shows one embodiment of a full sleeve lubricator and flow block.

FIG. 2 shows a perspective view of one embodiment of a full sleeve lubricator.

FIG. 3 is a vertical cross-section of the embodiment of FIG. 2.

FIG. 4 shows the embodiment of FIG. 3, with a plunger captured in the lubricator.

FIG. 5 shows a partial cutaway view of the embodiment of FIG. 2.

FIG. 6 shows a conventional flow-tee prior to installation of a lubricator.

FIG. 7 shows the wellhead of FIG. 6 with one embodiment of a full sleeve lubricator installed in place of the flow-tee.

FIG. 8 shows the embodiment of FIG. 7 in partial cutaway view.

FIG. 9 shows the embodiment of FIG. 8 with a plunger captured within the lubricator.

### DETAILED DESCRIPTION

The present invention now will be described more fully hereinafter with reference to the accompanying drawings, in which some, but not all embodiments of the invention are exemplified. Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only, and is not intended to limit the scope of the present invention.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation. Conventional components of the invention are elements that are well-known in the prior art and will not be discussed in detail for this disclosure.

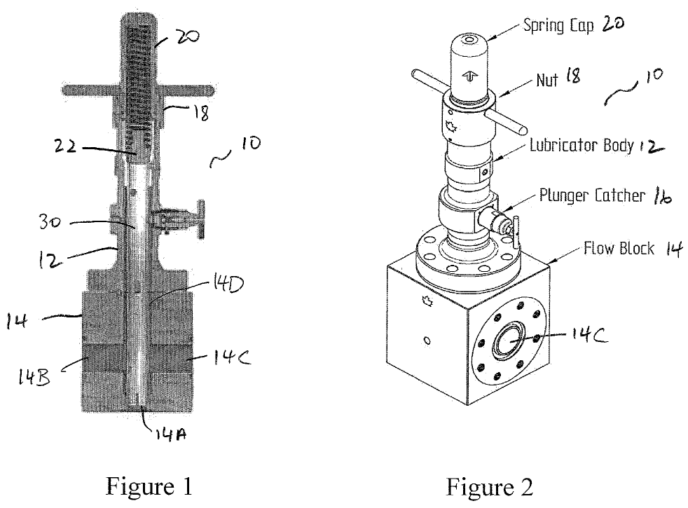

FIG. 1 shows an embodiment of a full sleeve lubricator of the present invention which may mitigate some disadvantages of the prior art. As used herein, a “full sleeve” means a sleeve which extends upwards into the lubricator, preferably all the way to contact the upper lubricator assembly, and extends downwards to a point near or below the production flow outlet, as described below. The term “concentric flow” means that a flow passage is provided in an annular passage which surrounds the sleeve.

As exemplified in FIGS. 1 and 2, in some embodiments, a lubricator 10 comprises a lubricator body 12 mounted to a flow block 14. The flow block 14 and lubricator 10 may be configured to be installed to directly replace a flow block in an existing installation, without modification to existing equipment. The lubricator 10 comprises a plunger catcher 16 and an upper lubricator assembly. The upper lubricator assembly comprises a nut 18, spring cap 20, a spring 24, and an anvil 22. The anvil 22 provides a travel stop for a plunger received into the lubricator, and the spring 24 may serve to cushion the impact. In one embodiment, the nut has an internal thread which engages an external thread formed on the lubricator body 12.

The flow block 14 defines an internal three-way or four-way fluid passage, with a lower inlet passage 14A, at least one side outlet port 14B for produced fluids, and an upper passage 14D. An additional side port 14C may be provided which allows installation of a kill valve (not shown). The lubricator body 12 defines a central flow passage in fluid communication with the upper passage 14D of the flow block. The sleeve 30 is inserted into the lubricator body and has a lower end 31 which is seated in the flow block inlet passage such that all produced fluid received in the flow block 14 through inlet passage 14A passes into the sleeve 30.

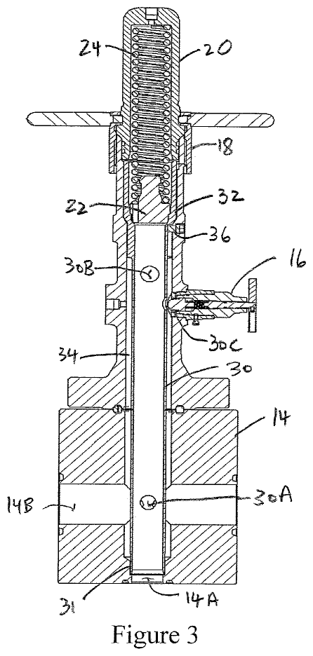

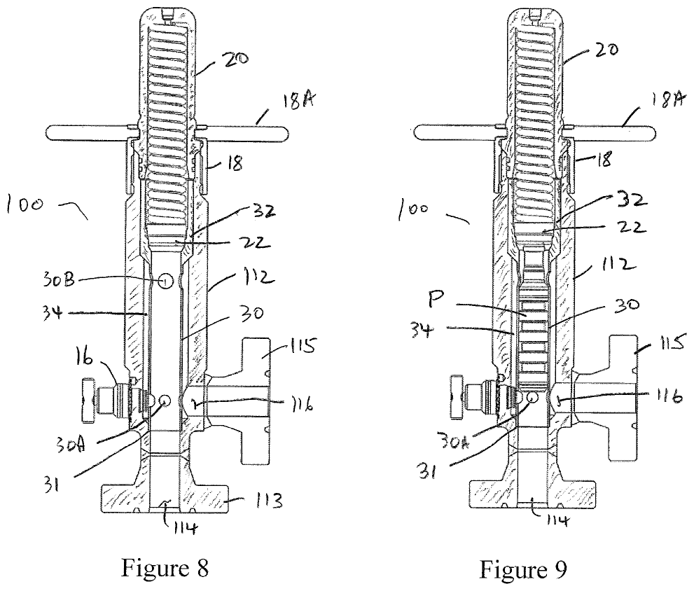

The sleeve 30 extends upwards into the lubricator body 12, preferably to a point above the installed plunger catcher 16, and more preferably such that a top end 32 of the sleeve 30 contacts the upper lubricator assembly, and the anvil 22 specifically. In one embodiment, the anvil 22 has a profile which fits within the top end 32 of the sleeve. In some embodiments, the top end 32 of the sleeve 30 may be flared to fit around the anvil 22, as exemplified in FIGS. 3 and 8, providing added space for the anvil and spring. The widened part 32 of the sleeve 30 prevents the sleeve from moving up as it abuts the cap 22, and prevents it from going down as it contacts a transition within the lubricator body, where the bore narrows. The sleeve interface within the lubricator body acts as a hangar for the sleeve such that the load from the anvil and spring is not transferred to the bottom of the sleeve, which may prevent buckling of the sleeve.

The sleeve 30 has an OD which is smaller than the ID of the lubricator body, creating an annular flow passage 34 between the two. In some embodiments, the sleeve 30 is cylindrical and is installed to fit concentrically within the ID of a cylindrical bore in the lubricator body, creating a relatively uniform annular passage. The sleeve 30 defines at least one lower hole 30A which is in fluid communication with the flow block side port 14B. The sleeve further defines at least one upper hole 30B which preferably is placed or extends above the plunger catcher 16, near an upper end of the sleeve, below the flared top end 32. In one embodiment, the at least one lower hole may not be required with certain valve or plunger configurations.

In one embodiment, the lower holes 30A may be positioned below the side outlet port 14B so the fluid from the upper holes 30B converges with the fluid from the lower holes 30A with opposite velocities in order to adjust the outlet velocity to the center of outlet port 14B. This configuration may mitigate sand erosion of the components.

Accordingly, a portion of the fluid flow which enters the sleeve 30 will exit the lower hole 30A, while the remaining fluid will flow upwards through the sleeve, exit the upper hole 30B, and flow back downwards in the annular passage 34 to exit through the flow block side port. The apportionment of flow between the upper hole(s) and lower hole(s) of the sleeve 30 may be varied by varying the relative size and/or number of the upper and lower holes. A larger apportionment to the upper hole may facilitate entry of a plunger into the lubricator. A smaller apportionment to the upper hole may reduce the velocity of the plunger entering the lubricator.

In some embodiments, the sleeve may define elongated slots (not shown) which extend between an upper portion of the sleeve and a lower portion to provide the functional equivalent of upper and lower holes. The sleeve openings, whether separate upper and lower holes or elongated slots, should provide a flow path for fluid above the plunger to escape the sleeve and fluid within the sleeve below the plunger to escape the sleeve.

The sleeve 30 defines an opening 30C through which the plunger catcher 16 may extend through to retain a plunger received into the lubricator. An alignment guide 36 rotationally orients the sleeve 30 within the lubricator body 12 such that the opening 30C aligns with the plunger catcher 16. The alignment guide 36 may comprise a slot and pin, or any other suitable alignment mechanism.

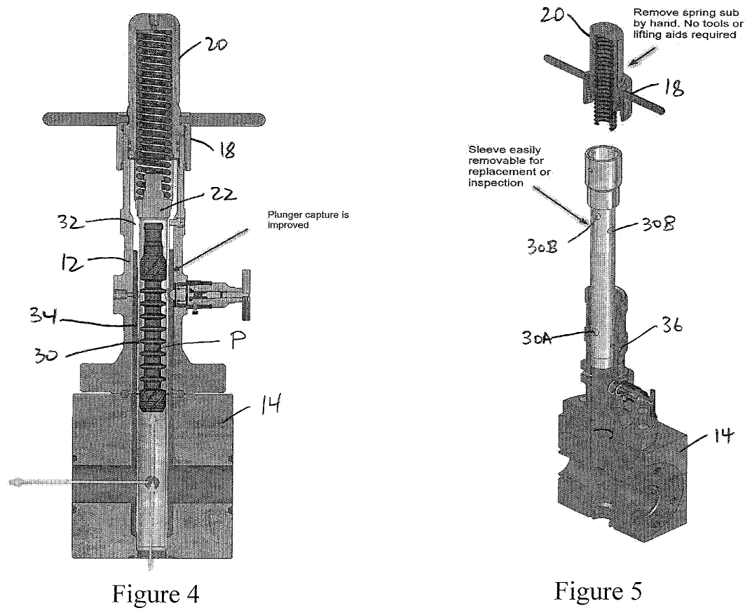

As may be seen in FIG. 4, when a plunger P is received into the lubricator, fluid is forced upward in the sleeve 30 above the plunger, however, this fluid may escape out the upper hole 30B until the plunger is captured by the plunger catcher 16. Produced fluids flowing from the wellbore may still exit the lower port 30A, below the plunger, as shown with flow arrows.

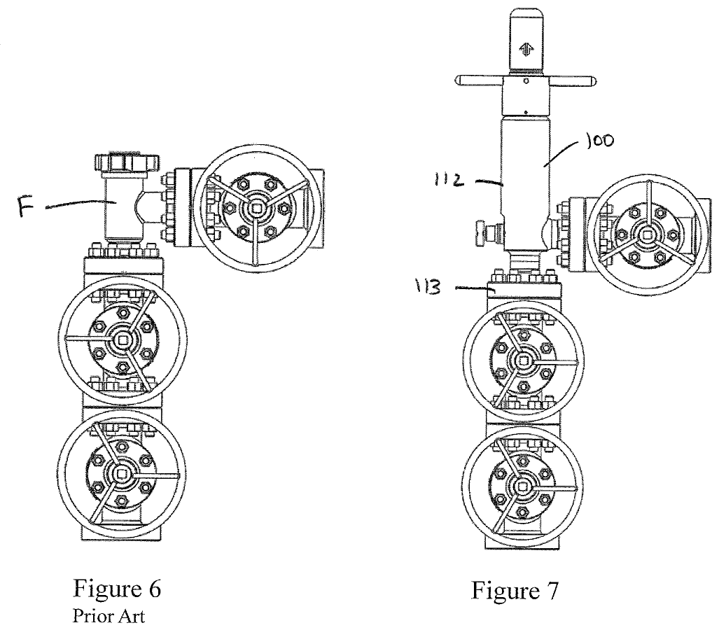

In an alternative embodiment, a full sleeve lubricator is configured to replace a conventional flow-tee (F), which is shown in FIG. 6. As seen in FIG. 7, a full sleeve lubricator 100 may be configured to be dimensionally similar to a flow-tee to permit direct replacement without modification. The lubricator body 112 may have a lower attachment flange 113, which may be welded or bolted to the body 112.

A sleeve 30 fits within the lubricator body 112, leaving an annular space 34 as described above. The lubricator body defines a lower inlet 114, and a side outlet port 116 which has an attachment flange 115. In one embodiment, the positioning of the lower attachment flange 113 and side attachment flange 115 permits direct replacement of a flow-tee, without modification. The upper lubricator assembly comprises the nut 18, the spring cap 20, and a spring 24, with an anvil 22.

A plunger catcher 16 may be positioned in any suitable position along the length of the lubricator body. In one embodiment, it may be conveniently positioned opposite the side outlet port 116 and aligned with an opening in the sleeve 30.

The sleeve defines at least one lower hole 30A and at least one upper hole 30B. In one embodiment, four lower holes 30A are provided which are in fluid communication with side outlet port 116. The lower end 31 of the sleeve may contact and be sealed into the lubricator body 112, closing off the annular space 34 and directing all flow from the annular space 34 into the side outlet port 116. Four upper holes 30B may be sized slightly larger than the lower holes, apportioning a slightly greater amount of flow to the upper holes. An alignment pin (not shown) may be provided to align the catcher hole and outlet holes.

As may be seen in FIGS. 5 and 8, the upper lubricator assembly is conveniently removable from the lubricator body. In a preferred embodiment, the nut 18 is a wing nut comprising handles 18A which permits manual unthreading without tools. The sleeve 30 may then be inspected, removed or replaced without removing the lubricator body from the fluid block.

Thus, a kit may comprise a lubricator and a plurality of different sleeves which fit into the lubricator. The sleeves may have different flow characteristics due to variations in the number and/or size of upper and lower holes, or may comprise a different material, or may be different in some dimension. Each variation may be suitable for a different intended purpose or result. An operator may easily switch out the installed sleeve for a different sleeve by manually removing the upper lubricator assembly.

### Exemplary Aspects

In view of the described devices, systems, and methods and variations thereof, certain more particularly described aspects of the invention are presented below. These particularly recited aspects should not however be interpreted to have any limiting effect on any different claims containing different or more general teachings described herein, or that the “particular” aspects are somehow limited in some way other than the inherent meanings of the language literally used therein.

Aspect 1: A lubricator comprising:
(a) an elongate lubricator body defining an inner bore, a lower inlet passage and a side outlet port;
(b) an upper lubricator assembly capping an upper end of the lubricator body;
(c) a sleeve extending substantially the length of the lubricator body, and having an outside diameter smaller than an inside diameter of the inner bore, thereby defining an annular flow passage therebetween, the annular flow passage in fluid communication with the side outlet port, wherein the sleeve defines an upper hole allowing fluid communication between an inner volume of the sleeve and the annular flow passage, and a lower hole allowing fluid communication between an inner volume of the sleeve and the annular flow passage.

Aspect 2: A lubricator comprising:
(a) a flow block defining a lower inlet passage, at least one side port, and an upper flow passage;
(b) an elongate lubricator body attached to the flow block, and defining an inner bore in fluid communication with the flow block upper flow passage;
(c) an upper lubricator assembly capping an upper end of the lubricator body;
(d) a sleeve having a lower end disposed in the flow block lower inlet passage and an upper end disposed in the lubricator body, and having an outside diameter smaller than an inside diameter of the inner bore and the inside diameter of the flow block upper flow passage, thereby defining an annular flow passage therebetween, the annular flow passage in fluid communication with the side outlet port, wherein the sleeve defines an upper hole allowing fluid communication between an inner volume of the sleeve and the annular flow passage, and a lower hole allowing fluid communication between an inner volume of the sleeve and the annular flow passage.

Aspect 3. The lubricator of aspect 1 or 2, wherein the sleeve extends such that the upper end is in contact with the upper lubricator assembly.

Aspect 4: The lubricator of one of aspects 1-3, wherein the upper lubricator assembly comprises a nut, a spring cap and an anvil.

Aspect 5: The lubricator of aspect 4 wherein the nut comprises a handle permitting manual tightening or removal.

Aspect 6. The lubricator of one of aspects 3-5, wherein the sleeve upper end is flared to surround the anvil, and contacts a lower end of the spring cap.

Aspect 7. The lubricator of aspect 6 wherein the flared upper end of the sleeve rests in contact with a transition in the lubricator body inner bore.

Aspect 8. The lubricator of any one of aspects 1-7, further comprising a plunger catcher, for capturing a plunger which is received into the sleeve in the lubricator body.

Aspect 9. The lubricator of any one of aspects 1-8, wherein the upper lubricator assembly is removable to permit removal of the sleeve without further disassembly, preferably manually removable without a tool.

Aspect 10. The lubricator of any one of aspects 1-9, comprising any combination of elements or features described herein, and/or omitting any one or more elements or features described herein.

Aspect 11. A kit comprising a lubricator of any one of aspect 1-10 and at least one additional different sleeve.

Aspect 12. A method of inspecting or replacing a sleeve within a lubricator, comprising the step of removing an upper lubricator assembly to access the sleeve and removing the sleeve, without further disassembly.

### Interpretation

The forgoing description supplies specific details in order to provide a thorough understanding. Nevertheless, the skilled artisan would understand that the apparatuses, systems, and associated methods of using the apparatuses and systems can be implemented and used without employing these specific details. Indeed, the apparatuses, systems, and associated methods can be placed into practice by modifying the illustrated apparatus and associated methods and can be used in conjunction with any other apparatus and techniques conventionally used in the industry.

The corresponding structures, materials, acts, and equivalents of all means or steps plus function elements in the claims appended to this specification are intended to include any structure, material, or act for performing the function in combination with other claimed elements as specifically claimed.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

1. A lubricator comprising:
(a) an elongate lubricator body, and defining an inner bore, a lower inlet passage and a side outlet port;
(b) an upper lubricator assembly capping an upper end of the lubricator body;
(c) a sleeve extending the length of the lubricator body, and having an outside diameter smaller than an inside diameter of the inner bore, thereby defining an annular flow passage therebetween, the annular flow passage in fluid communication with the side outlet port wherein the sleeve defines an upper hole allowing fluid communication between an inner volume of the sleeve and the annular flow passage, and a lower hole allowing fluid communication between an inner volume of the sleeve and the annular flow passage.

2. The lubricator of claim 1, wherein the sleeve extends such that the upper end is in contact with the upper lubricator assembly.

3 The lubricator of claim 1, wherein the upper lubricator assembly comprises a nut, a spring cap and an anvil.

4 The lubricator of claim 3 wherein the nut comprises a handle permitting manual tightening or removal.

5. The lubricator of claim 3 wherein the sleeve upper end is flared to surround the anvil, and contacts a lower end of the spring cap.

6. The lubricator of claim 5 wherein the flared upper end of the sleeve rests in contact with a transition in the lubricator body inner bore.

7. The lubricator of claim 1, further comprising a plunger catcher, for capturing a plunger which is received into the sleeve in the lubricator body.

8. The lubricator of claim 1, wherein the upper lubricator assembly is removable to permit removal of the sleeve without further disassembly, optionally manually removable without a tool.

9. A lubricator comprising:
(a) a flow block defining a lower inlet passage, at least one side port, and an upper flow passage;
(b) an elongate lubricator body attached to the flow block, and defining an inner bore in fluid communication with the flow block upper flow passage;
(c) an upper lubricator assembly capping an upper end of the lubricator body;
(d) a sleeve having a lower end disposed in the flow block lower inlet passage and an upper end disposed in the lubricator body, and having an outside diameter smaller than an inside diameter of the inner bore and the inside diameter of the flow block upper flow passage, thereby defining an annular flow passage therebetween, the annular flow passage in fluid communication with the side outlet port, wherein the sleeve defines an upper hole allowing fluid communication between an inner volume of the sleeve and the annular flow passage, and a lower hole allowing fluid communication between an inner volume of the sleeve and the annular flow passage.

10. The lubricator of claim 9, wherein the sleeve extends such that the upper end is in contact with the upper lubricator assembly.

11. The lubricator of claim 9, wherein the upper lubricator assembly comprises a nut, a spring cap and an anvil.

12. The lubricator of claim 11 wherein the nut comprises a handle permitting manual tightening or removal.

13. The lubricator of claim 11 wherein the sleeve upper end is flared to surround the anvil, and contacts a lower end of the spring cap.

14. The lubricator of claim 13 wherein the flared upper end of the sleeve rests in contact with a transition in the lubricator body inner bore.

15. The lubricator of claim 9, further comprising a plunger catcher, for capturing a plunger which is received into the sleeve in the lubricator body.

16. The lubricator of claim 9, wherein the upper lubricator assembly is removable to permit removal of the sleeve without further disassembly, optionally manually removable without a tool.

17. A kit comprising a lubricator of claim 1 or claim 9, and at least one additional different sleeve.

18. A method of inspecting or replacing a sleeve within a lubricator, comprising the step of removing an upper lubricator assembly to access the sleeve and removing the sleeve, without further disassembly.

19. A kit comprising a lubricator of claim 9, and at least one additional different sleeve.
